(19) United States
(12) Patent Application Publication
(10) Pub. No.: US 2012/0138150 A1
(43) Pub. Date: Jun. 7, 2012

(54) FLUID SUPPLY SYSTEM AND FLUID SUPPLY METHOD

(75) Inventors: YAN-PO LIN, Shenzhen City (CN); Chengming He, Shenzhen (CN)

(73) Assignee: Shenzhen China Star Optoelectronics Technology Co. LTD., Shenzhen Co., Ltd. (CN)

(21) Appl. No.: 13/220,680

(22) Filed: Aug. 30, 2011

(30) Foreign Application Priority Data
Dec. 6, 2010 (CN) 201010575713.2

(51) Int. Cl. F15D 1/00

(52) U.S. Cl. 137/1; 137/386

(57) ABSTRACT

The present invention discloses a fluid supply system, which comprises at least two flow meters and a control device. The at least two flow meters are disposed on at least one water pipeline and at least one lotion pipeline for generating a plurality of flow values. The control device is electrically connected with the at least to flow meters for receiving the flow values to confirm amounts of water and lotion supplied to at least one lotion sink. The present invention further discloses a fluid supply method. The control device judges whether fluid level sensors disposed on the lotion sink fail by the amounts of water and lotion, to prevent the lotion in the lotion sink from overflowing when the sensor fails, thereby reducing cost.

### TECHNICAL FIELD OF THE INVENTION

The present invention relates to a fluid supply system and a fluid supply method, and more particularly, to a fluid supply system and fluid supply method thereof for cleaning liquid crystal display (LCD) glasses.

### BACKGROUND OF THE INVENTION

A cleaning process plays an important role in the LCD manufacturing technology. Nowadays, a method of cleaning a glass substrate for the LCD mainly comprises cleaning out residual liquid crystals, edging dusts and foreign matters from a surface of the glass by using water and lotion in concert with an ultrasonic wave.

Please refer to FIG. 1, which is schematic diagram of a fluid supply system of a glass cleaning apparatus in prior art. The conventional fluid supply system comprises at least one lotion sink 100, a lotion supply device 110, a water supply device 120, a plurality of pipelines and valves thereof. Amongst, the lotion supply device 110 comprises a measuring tank 1101, the measuring tank 1101 is provided with a plurality of sensors 1102 for checking fluid levels. The fluid levels are LL, M and H from low to high. In the prior art, a process for providing lotion to the glass cleaning apparatus 300 is as follows:

Lotion is supplied to the measuring tank 1101, and the fluid level of the lotion is judged whether it reaches a predetermined fluid level or not according to the sensors 1102 on the measuring tank 1101. If so, the lotion supply is stopped, and the lotion is supplied into the lotion sink 100. Then, de-ionized water is supplied to the lotion sink 100 by the water supply device 120 to mix up a cleaner solution of a predetermined proportion. The cleaner solution circulates in the at least one lotion sink 100 and the glass cleaning apparatus 300 via the plural pipelines and the valves thereof.

A plurality of sensors 102 are provided on the lotion sink 100 for checking the fluid level. The fluid levels are LL, L, M1, M2, H and HH from low to high. The fluid level of the lotion is judged whether it reaches a predetermined fluid level, e.g. H, or not. If so, the supplies of the lotion and de-ionized water are stopped. If not, it is judged whether the fluid level reaches HH. If the sensor 102 positioned at HH detects the cleaner solution, it indicates that the cleaner solution overflows and the sensor 102 at the position H fails. At this time, the supplies of lotion and de-ionized water are stopped, and the excess cleaner solution is drained away.

After cleaning, the glass brings away some cleaner solution, resulting in losses of the lotion and de-ionized water in the lotion sink 100, and therefore timely supplies of lotion and water are necessary. However, the conventional fluid supply system utilizes the sensors 102 of the lotion sink 100 to detect the fluid level of the supplied cleaner solution. When the sensor 102 is abnormal, the lotion supply device 110 and the water supply device 120 fail to response in time, and therefore often causing the abnormal depletion of the lotion, so the cost is increased. Besides, the additive amount of the lotion can be confirmed only by using the measuring tank 1101 in concert with the sensors 1102, and therefore cannot be easily and accurately known. As a result, concentration change of the cleaner solution leads to a problem of parameter variance in the cleaning process.

### SUMMARY OF THE INVENTION

Accordingly, an objective of the present invention is to provide a fluid supply system for cleaning glasses, which accurately supplies lotion and water amounts by at least flow meters in coordination with a control device to solve the problem describe above.

Another objective of the present invention is to provide a fluid supply method for cleaning glasses, which uses the fluid supply system for cleaning glasses to reduce unnecessary consumption of lotion and improve the existing fluid supply flow.

To achieve the foregoing objectives of the present invention, the present invention adopts the following scheme. That is, the fluid supply system for cleaning glasses of the present invention comprises at least one lotion sink, a lotion supply device, a water supply device, at least two flow meters and a control device. The lotion supply device has at least one lotion pipeline respectively connected to the at least one lotion sink for supplying solution. The water supply device has at least one water pipeline respectively connected to the at least one lotion sink for supplying water. The at least two flow meters are provided to the at least one lotion pipeline and the at least one water pipeline, respectively, for obtaining flow values of the lotion and water delivered to the lotion sink. The control device is electrically connected to the at least two flow meters for receiving the plural flow values, so as to confirm the lotion and water amounts supplied to the at least one lotion sink.

The control device is further used for opening the lotion pipeline to deliver the lotion to the lotion sink; judging whether the lotion amount in the lotion sink reaches a first predetermined amount by using the plural flow values, if so, the control device closes the lotion pipeline and opens the water pipeline to deliver water to the at least one lotion sink; and judging whether the water amount in the lotion sink reaches a second predetermined amount, if so, the control device closes the water pipeline.

The fluid supply system further comprises a plurality of fluid level sensors provided on each lotion sink and electrically connected with the control device for transmitting signals to the control device when detecting the fluid level of the lotion sink. In particular, the control device further judges whether the fluid level is detected by the plural fluid level sensors of the lotion sink, if so, the step of closing the water pipeline is triggered. The control device is further used to close the water pipeline and raise an abnormality alarm when the plural fluid level sensors of the at least one lotion sink fail to detect the fluid level.

The fluid supply system further comprises at least one lotion pipeline automatic valve and at least one water pipeline automatic valve. The at least one lotion pipeline automatic valve is disposed at the at least one lotion pipeline for opening or closing the at least one lotion pipeline. Furthermore, the at least one water pipeline automatic valve is disposed at the at least one water pipeline for opening or closing the at least one water pipeline.

To achieve another foregoing objectives of the present invention, the present invention further provides a fluid supply method for a fluid supply system. The fluid supply system comprises at least one lotion sink, at least one lotion pipeline and at least one water pipeline respectively connected to the at least one lotion sink, at least two flow meters and a control device, wherein the at least two flow meters are used for obtaining flow values of lotion and water delivered to the lotion sink, and the control device is used for receiving the plural flow values. The method comprises the following steps:

(A) opening the lotion pipeline to deliver the lotion to the at least one lotion sink by the control device; (B) judging whether a lotion amount in the at least one lotion sink reaches a first predetermined amount by the control device using the plural flow values and executing step (C) if YES while returning to execute step (B) if NO; (C) closing the lotion pipeline by the control device; (D) opening the water pipeline to deliver water to the at least one lotion sink; (E) judging whether a water amount in the at least one lotion sink reaches a second predetermined amount by the control device using the plural flow values and executing step F if YES, while returning to execute step E if NO; and (F) closing the water pipeline by the control device.

In another embodiment of the present invention, the fluid system further comprises a plurality of fluid level sensors disposed on each lotion sink for transmitting a signal when a fluid level of the lotion sink is detected; the follow steps are included before step F:

(E1) judging whether a predetermined fluid sensor among the plural fluid sensors detects the fluid level by the control device, and executing the step F if YES. (E2) stopping supply of the lotion and raising an abnormality alarm if the control device determines that the predetermined fluid level sensor fails to detect the fluid level. In step E1, it is judged whether the fluid level detected by the plural fluid level sensors matches a sum of the first predetermined amount and the second predetermined amount.

In accordance with the fluid supply system and fluid supply method for cleaning glasses, lotion and water amounts are accurately supplied by the at least two flow meters in concert with the control device, so as to solve the problem that the conventional fluid supply system only uses the measuring tank and cannot accurately know the proportion between lotion and water. In addition, the control device calculates required lotion and water amounts which have been supplied to the lotion sink according to the plural flow meters, and then judges whether the fluid level sensor of the lotion sink detects the predetermined fluid level. If not, it indicates that the fluid level sensor fails, then fluid supply is stopped and an alarm is raised to prevent the cleaner solution in the lotion sink from overflowing in the failure.

To make the present invention more manifest and understandable, preferred embodiments will be described in detail in conjunction with the appending drawings:

### BRIEF DESCRIPTION OF THE DRAWINGS

FIG. 1 is a schematic diagram showing a fluid supply system of a glass cleaning apparatus in prior art.

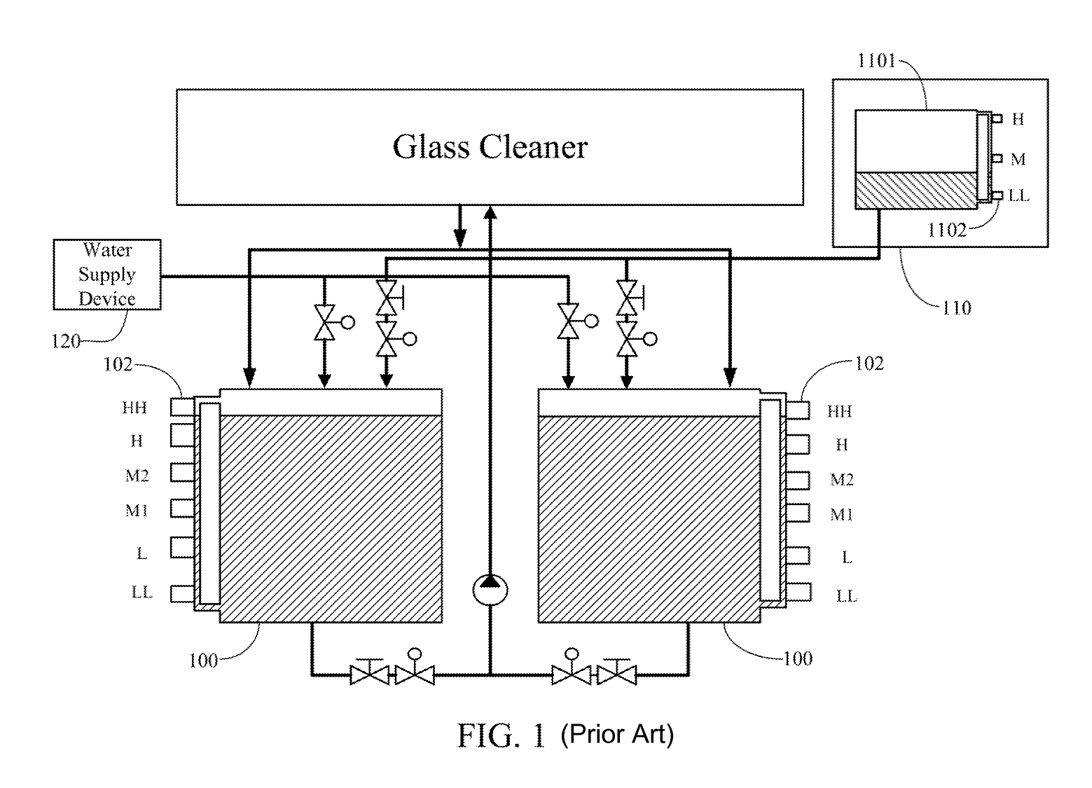

FIG. 2 is a schematic diagram of a fluid supply system of a preferred embodiment in accordance with the present invention.

FIG. 3 is a flowchart of a fluid supply method of a preferred embodiment in accordance with the present invention.

FIG. 4 is a flow chart of a fluid supply method of another preferred embodiment in accordance with the present invention.

### DETAILED DESCRIPTION OF THE INVENTION

Various embodiments are provided in the specification of the present invention for describing technical features of different implementations of the present invention. Amongst, arrangements of the respective components in the embodiments are presented for illustrating the contents disclosed by the present invention rather than limiting the present invention. Some of reference numbers in the drawings of the embodiments are repeated for the purpose of simplifying the description rather than implying relationship between different embodiments.

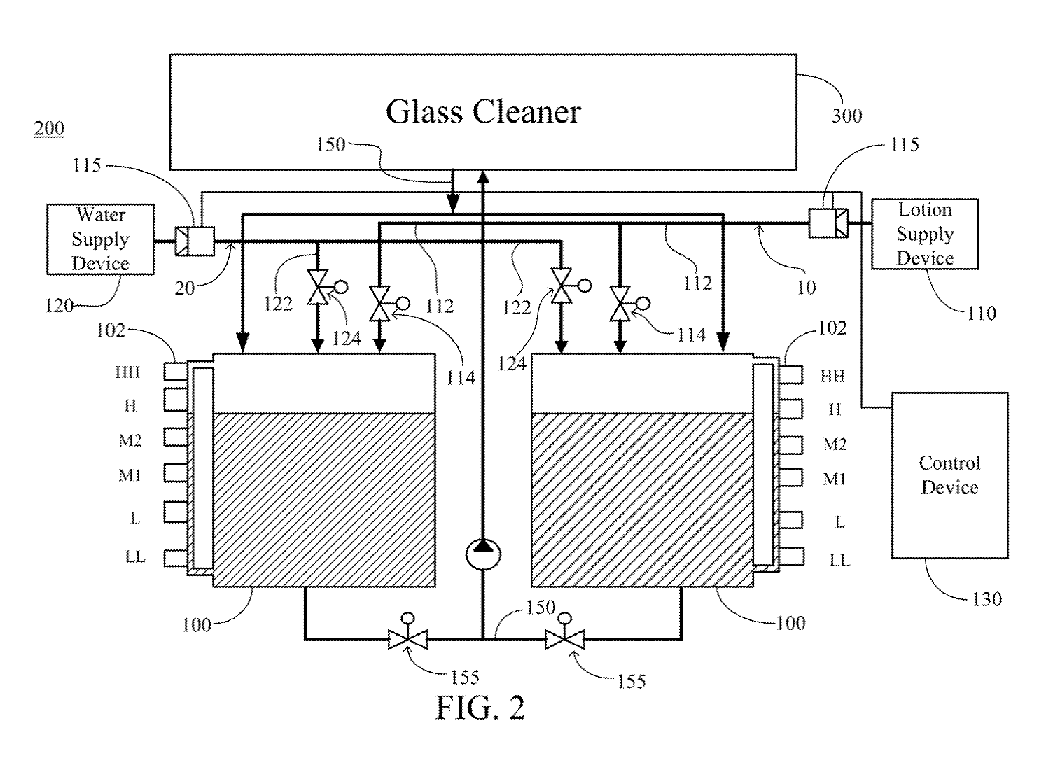

Please refer to FIG. 2, which is a schematic diagram of a fluid supply system of a preferred embodiment in accordance with the present invention. The fluid supply system 200 for cleaning glasses in accordance with the present preferred embodiment comprises at least one lotion sink 100, a lotion supply device 110, a water supply device 120, at least two flow meters 1151 and 1152, and a control device 130.

The lotion supply device 110 has at least one lotion pipeline 112 respectively connected to the at least one lotion sink 100 for supplying lotion 10. In addition, at least one lotion pipeline automatic valve 114 is disposed on the at least one lotion pipeline 112 to be used for opening or closing the at least one lotion pipeline 112.

The water supply device 120 has at least one water pipeline 122 respectively connected to the at least one lotion sink 100 for supplying water 20. Preferably, the water supply device 120 is used for supplying de-ionized water or pure water. In addition, at least one water pipeline automatic valve 124 is disposed on the at least one water pipeline 122 to be used for opening or closing the at least one water pipeline 122.

Each lotion sink 100 has a heater (not shown) for heating cleaner solution in the lotion sink 100 to a predetermined temperature. In addition, each lotion sink 100 is provided with a conductivity meter or a resistance meter (not shown) for monitoring whether the concentration of the cleaner solution in the lotion sink is abnormal during the producing process. The cleaner solution mixed up by the water 20 and the lotion 10 circulates in the at least one lotion sink 100 and the glass cleaning apparatus 300 via the plural pipelines 150 and the plural valves 155.

The at least two flow meters 1151 and 1152 are disposed on the at least one lotion pipeline 112 and the at least one water pipeline 122, respectively, for obtaining flow values of the lotion 10 and the water 20 delivered to the lotion sink 100. Specifically, the flow meter 1151 or 1152 can be a digital vortex flow meter, a throttling flow meter, a slit flow meter, a volumetric flow meter, an electromagnetic flow meter, an ultrasonic flow meter or the like.

The control device 130 is electrically connected with the at least two flow meters 1151 and 1152 for receiving the plural flow values to confirm the amounts of the lotion 10 and the water 20 supplied to the at least one lotion sink 100.

The control device 130 is further used for opening the lotion pipeline 112 to deliver the lotion 10 to the lotion sink 100. The control device 130 utilizes the plural flow values to judge whether the amount of the lotion 10 in the lotion sink 100 reaches a first predetermined amount. If so, the control device 130 closes the lotion pipeline 112 and opens the water pipeline 122 so as to deliver the water 20 to the at least one lotion sink 100. The control device 130 utilizes the plural flow values to judge whether the amount of the water 20 in the lotion sink 100 reaches a second predetermined amount. If so, the control device 130 closes the water pipeline 122.

For example, the control device 130 records the flow time, and therefore the amount of the lotion 10 or water 20 can be known from a product of the flow value and the time. For instance, the flow value of the flow meter 1151 on the lotion pipeline 112 is 1 (liter/sec), and the flow time recorded by the control device 130 is 5 seconds, and therefore it is obtained that the lotion 10 flowed into the lotion sink 100 is 5 liters. The flow value of the flow meter 1152 on the water pipeline 122 is 2 (liter/sec), and the flow time recorded by the control device 130 is 5 seconds, and therefore it is obtained that the water 20 flowed into the lotion sink 100 is 10 liters. Further, opening or closing the at least one water pipeline automatic valve 124 and the at least one lotion pipeline automatic valve 114 is controlled accordingly. More specifically, the control device 130 can be further used for controlling a proportion of water and lotion in the at least one lotion sink 100. For the above example, if 100 liters of the cleaner lotion of a concentration of 10% is to be obtained, it can be controlled that the lotion pipeline 114 is opened for 10 seconds and then closed, and the water pipeline 124 is opened for 45 seconds and then closed.

The fluid supply system 200 further comprises a plurality of fluid level sensors 102 disposed on each lotion sink 100 and electrically connected with the control device 130 (not shown) for transmitting a signal to the control device 130 when a fluid level of the lotion sink 100 is detected. The fluid levels are LL, L, M1, M2, H, and HH from low to high. Specifically, the control device 130 is further used to judge whether the plural fluid sensors 102 of the lotion sink 100 detect the fluid level or not before closing the water pipeline 122, and trigger a step of closing the water pipeline 122 if so. For example, the water pipeline automatic valve 124 is closed when it is determined according to the signal that the fluid level sensor 102 positioned at the fluid level H detects the fluid level, so as to prevent the cleaner solution from overflowing. The control device 130 is further used to close the water pipeline 122 and raise an abnormality alarm when it is determined that the plural fluid level sensors 102 of the at least one lotion sink 100 fail to detect the fluid level. For example, the control device 130 is able to determine the actual fluid level in the lotion sink 100 after obtaining the amount of the lotion 10 or water 20 flowed into the lotion sink 100 according to the product of the flow value and the time. Therefore, if the control device determines that the fluid level sensor 102 positioned at the fluid level H fails to detect the fluid level according the signal when the actual fluid level reaches H, it indicates that the fluid level sensor 102 representing H is out of order. Thereby the control device 130 closes the water pipeline automatic valve 120 in order to prevent the cleaner solution from overflowing.

To sum up, the problem that the conventional glass cleaning apparatus only uses the measuring tank and the sensors 102 so cannot accurately know the proportion of lotion to water is solved by accurately supply the amounts of the lotion 10 and the water through the at least two flow meters in coordination with the control device 130. Further, the control device 130 can know the total amount of the cleaner solution in the lotion sink 100 at real time by passing back the flow values of the flow meters 1151 or 1152 to the control device 130. In addition, the control device 130 is able to confirm whether the plural fluid level sensors 102 are normal or not according to the total amount of the cleaner solution in the lotion sink 100. If the fluid level sensor 102 fails, the water pipeline automatic valve 124 can be closed in real time, so that overflow of the cleaner solution which causes a waste of the lotion 10 will not be brought about.

The fluid supply method for the fluid supply system in accordance with a preferred embodiment of the present invention will be described below in detail. In the present preferred embodiment, the fluid supply method is implemented by using the fluid supply system 200 for cleaning glasses of the above embodiment. Please refer to FIG. 2 again, the fluid supply system 200 comprises at least one lotion sink 100, a lotion supply device 110, a water supply device 120, at least one lotion pipeline 112 and water pipeline 122 connected to the at least one lotion sink 100, respectively, at least two flow meters 1151 or 1152, at least water pipeline automatic valve 124, at least one lotion pipeline automatic valve 114 and a control device 130. Amongst, the at least two flow meters 1151 or 1152 are used for obtaining the flow values of the water 20 and the lotion 10 delivered to the lotion sink 100. The control device 130 is used for receiving the plural flow values. Descriptions of the above components can be referred to the foregoing, and therefore is omitted here.

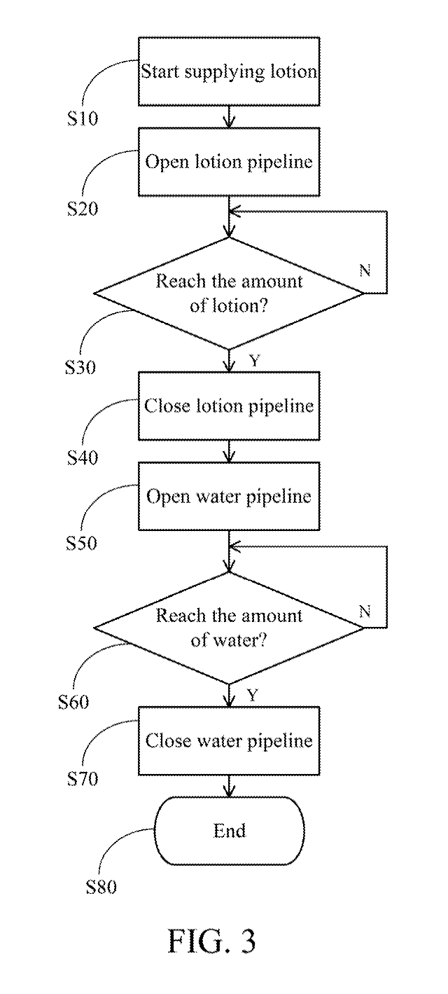

Please refer to FIG. 2 and FIG. 3 at the same time, FIG. 3 is a flowchart of the fluid supply method of the preferred embodiment of the present invention. The method starts at step S10.

In step S10, supply of the lotion 10 is started. In the preferred embodiment, the lotion supply device 110 starts to supply the lotion 10, and then step S20 is executed. The lotion supply device 110 is controlled by the control device 130 and starts to supply a small amount of lotion 10. It is noted that the lotion pipeline automatic valve 114 is closed at this time. Therefore, the lotion 10 is just filled in the lotion pipeline 112 rather than supplied into the lotion sink 100.

In step S20, the control device 130 opens the lotion pipeline 112 to deliver the lotion 10 to the at least one lotion sink 100. In the present preferred embodiment, the lotion pipeline automatic valve 114 is opened by the control device 130 so as to open the lotion pipeline 122, and then the step S30 is executed. At this time, the lotion 10 starts to be supplied into the lotion sink 100, and the flow meter 1151 begins generating a plurality of flow values to the control device 130.

In step S30, the control device 130 judges whether the amount of the lotion 10 in the at least one lotion sink 100 reaches a first predetermined amount or not by using the plural flow values. If so, the step S40 is executed. If not, it is returned to the step S30 to continue judgment. For example, the control device 130 records the filling time, and obtains the filled amount of the lotion 10 by multiplying the flow value and the time, so as to judge whether the first predetermined amount is reached or not.

In step S40, the control device 130 closes the lotion pipeline 112. In the preferred embodiment, the lotion pipeline automatic valve 114 is closed by the control device 130 so as to close the lotion pipeline 112, and then the step S50 is executed. That is, when the amount of the lotion 10 has reached the first predetermined amount, the lotion pipeline automatic valve 114 is closed to stop the supply of the lotion 10.

In step S50, the control device 130 opens the water pipeline 122 for delivering the water 20 to the at least one lotion sink 100. In the preferred embodiment, the water pipeline automatic valve 124 is opened by the control device 130, so as to open the water pipeline 122, and then the step S60 is executed. At this time, the water 20 starts to be supplied into the lotion sink 100, and the flow meter 1152 begins generating a plurality of flow values to the control device 130.

In step S60, the control device 130 judges whether the amount of the water 20 in the at least one lotion sink 100 reaches a second predetermined amount by using the plural flow values. If so, then a step S70 is executed, while if not, it is returned to step S60 to keep on judging. For example, the control device 130 records injection time. The amount of the water 20 injected can be known by calculating a multiplication of the flow value and the time, and thereby judging whether the second predetermined amount is reached or not.

In step S70, the control device 130 closes the water pipeline 122. In the preferred embodiment, the water pipeline automatic valve 120 is closed by the control device 130, and then a step S80 is executed. That is, after the amount of the water 20 has reached the predetermined value, the water pipeline automatic valve 124 is closed to stop supplying the water 20.

In step S80, the process of supplying the cleaner solution is ended.

In accordance with the fluid supply method of the present embodiment, the problem that the conventional fluid system cannot accurately know the proportion of lotion and water by using only the measuring tank and the fluid level sensors is solved by at least two flow meters 1151 or 1152 in coordination with the control device 130 to accurately supply the amounts of the lotion 10 and the water 20.

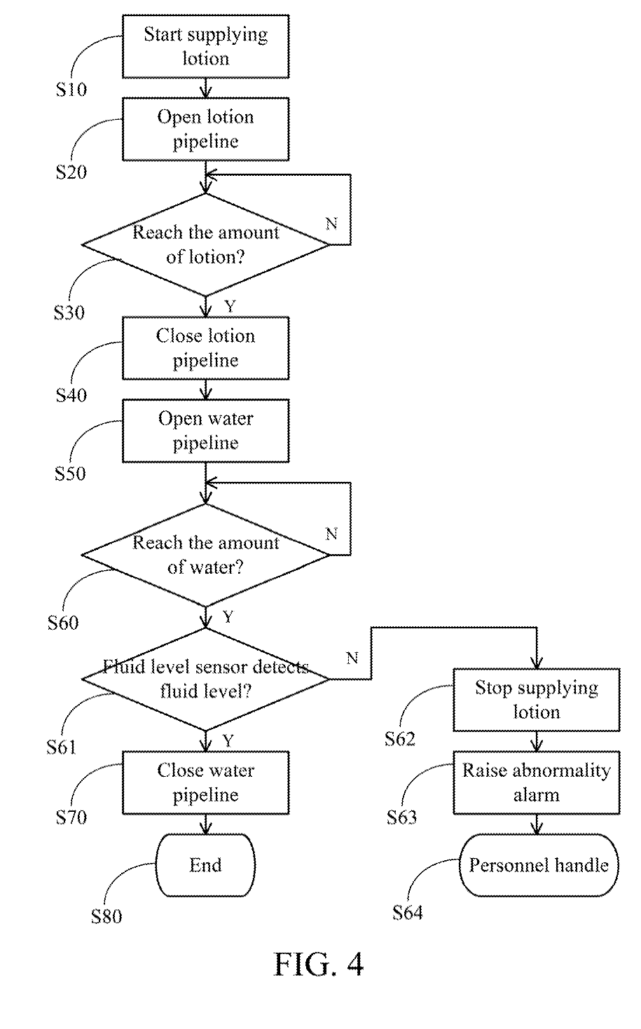

A fluid supply method for the fluid supply system of another preferred embodiment of the present invention will be described in detail as follows. Please refer to FIG. 2 and FIG. 4, FIG. 4 is a flowchart of the fluid supply method of another preferred embodiment of the present invention. The fluid supply system further comprises a plurality of fluid level sensors 102 disposed on each lotion sink 100 for transmitting signals to the control device when the fluid level of the lotion sink 100 is detected. The method starts at step S10.

In step S10, the lotion 10 starts to be supplied. In step S20, the control device 130 opens the lotion pipeline 122 to deliver the lotion 10 to the at least one lotion sink 100. In step S30, the control device 130 uses the plural flow values to judge whether the amount of the lotion 10 in the at least one lotion sink 100 reaches a first predetermined amount. If so, a step S40 is executed. If not, it returns to execute the step S30. In step S40, the control device 130 closes the lotion pipeline 112. In step S50, the control device 130 opens the water pipeline 122 to deliver the water 20 to the at least one lotion sink 100. In step S60, the control device 130 uses the plural flow values to judge whether the amount of the water 20 in the at least one lotion sink 100 reaches a second predetermined amount. If so, then a step S61 is executed. If not, then it returns to execute the step S60. Amongst, explanation of the above steps can be referred to the foregoing, and the descriptions thereof are omitted herein. The difference from the previous embodiment is that the following step is further included before step S70:

In step S61, the control device 130 judges whether a predetermined fluid level sensor among the plural fluid level sensors 102 detects the fluid level or not. If so, a step S70 is executed. If not, a step S62 is executed. Specifically, according to the plural flow values, in coordination with the control device 130, it is possible to confirm the necessary amounts of the lotion 10 and the water 20 have been supplied into the lotion sink 100, and then the fluid level sensor 102 of the lotion sink 100 judges whether the cleaner solution has reached a predetermined fluid level, e.g. the fluid level H. If not, it indicates that the predetermined fluid level sensor 102 at the fluid level H is out of order.

In step S62, if the control device 130 determines that the plural fluid level sensor 102 of the lotion sink 100 fail to detect the fluid level, it stops supplying the lotion 10. In this another preferred embodiment, the supply of the lotion 10 is stopped by the lotion supply device 110 to avoid unnecessary consumption of the lotion 10, and then a step S63 is executed.

In step S63, an abnormality alarm is raised. That is, the abnormality alarm indicating that the fluid level sensor 102 of the lotion sink 100 is out of order, and then a step S64 is executed.

In step S64, it is handled by personnel. That is, after raising the alarm, the personnel may conduct repairing.

To sum up, after the control device 130 calculates that the required amounts of the lotion 10 and the water 20 have been supplied into the lotion sink 100 according to the flow values, the fluid level sensor 102 of the lotion sink 100 judges whether the cleaner solution of the lotion sink 100 has reached the predetermined fluid level. If not, it indicates that the fluid level sensor 102 is out of order, the fluid supply is stopped and the alarm is raised to prevent the cleaner solution of the lotion sink 100 from overflowing.

Although the present invention has been disclosed by describing the preferred embodiments as above, the embodiments are not used for limiting the present invention. Various modifications and alterations can be made by persons skilled in this art without departing from the spirit and realm of the present invention, and therefore the claimed scopes of the present invention to be protected should be according to the scopes defined in the appended claims.

What is claimed is:

1. A fluid supply system comprising:
at least one lotion sink;
a plurality of fluid level sensors disposed on each lotion sink for detecting a fluid level of the lotion sink;
a lotion supply device having at least one lotion pipeline respectively connected to the at least one lotion sink, and for supplying lotion; and
a water supply device having at least one water pipeline respectively connected to the at least one lotion sink, and for supplying water;
wherein the fluid supply system for cleaning glasses further comprising:
at least one conductivity meter disposed on the lotion sink for obtaining a concentration of the lotion in the lotion sink;
at least two flow meters respectively disposed at the at least one lotion pipeline and the at least one water pipeline for obtaining flow values of the lotion and water delivered to the lotion sink;
a control device electrically connected with the at least two flow meters and the fluid level sensors for receiving the flow values to confirm amounts of the lotion and the water supplied to the at least one lotion sink, and confirm whether the fluid level sensors are normal or not according to the amounts of the water and the lotion.

2. The fluid supply system according to claim 1, wherein the control device is further used for opening the lotion pipeline to deliver the lotion to the lotion sink;
judging whether the amount of the lotion in the lotion sink reaches a first predetermined amount or not by using the flow values, closing the lotion pipeline and opening the water pipeline to deliver the water to the at least one lotion sink if so; and judging whether the amount of the water in the lotion sink reaches a second predetermined amount by using the flow values, and closing the water pipeline if so.

3. The fluid supply system according to claim 2, wherein the control device is used further fore judging whether a predetermined fluid level sensor among the fluid level sensors of the lotion sink detects a fluid level or not before closing the water pipeline, and triggering the step of closing the water pipeline if so.

4. The fluid supply system according to claim 3, wherein the control device is used further for closing the water pipeline and raising an abnormality alarm when the predetermined fluid level sensor amount the fluid level sensors of the at least one lotion sink is determined as failing to detect the fluid level.

5. The fluid supply system according to claim 3, wherein the fluid supply system further comprising:
at least one lotion pipeline automatic valve disposed at the at least one lotion pipeline for opening or closing the at least one lotion pipeline; and
at least one water pipeline automatic valve disposed at the at least one water pipeline for opening or closing the at least one water pipeline.

6. The fluid supply system according to claim 1, wherein the flow meter is a digital vortex flow meter, a throttling flow meter, a slit flow meter, a volumetric flow meter, an electromagnetic flow meter, or an ultrasonic flow meter.

7. A fluid supply system comprising:
at least one lotion sink;
a lotion supply device having at least one lotion pipeline respectively connected to the at least one lotion sink, and for supplying lotion; and
a water supply device having at least one water pipeline respectively connected to the at least one lotion sink, and for supplying water;
wherein the fluid supply system for cleaning glasses further comprising:
at least two flow meters respectively disposed at the at least one lotion pipeline and the at least one water pipeline for obtaining flow values of the lotion and water delivered to the lotion sink; and
a control device electrically connected with the at least two flow meters for receiving the flow values to confirm amounts of the lotion and the water supplied to the at least one lotion sink.

8. The fluid supply system according to claim 7, wherein the control device is further used for opening the lotion pipeline to deliver the lotion to the lotion sink;
judging whether the amount of the lotion in the lotion sink reaches a first predetermined amount or not by using the flow values, closing the lotion pipeline and opening the water pipeline to deliver the water to the at least one lotion sink if so; and judging whether the amount of the water in the lotion sink reaches a second predetermined amount by using the flow values, and closing the water pipeline if so.

9. The fluid supply system according to claim 8, wherein the fluid supply system further comprising a plurality of fluid level sensors disposed on each lotion sink and electrically connected with the control device for transmitting a signal to the control device when a fluid level of the lotion sink is detected.

10. The fluid supply system according to claim 9, wherein the control device is used further fore judging whether a predetermined fluid level sensor among the fluid level sensors of the lotion sink detects a fluid level or not before closing the water pipeline, and triggering the step of closing the water pipeline if so.

11. The fluid supply system according to claim 10, wherein the control device is used further for closing the water pipeline and raising an abnormality alarm when the predetermined fluid level sensor amount the fluid level sensors of the at least one lotion sink is determined as failing to detect the fluid level.

12. The fluid supply system according to claim 7, wherein the fluid supply system further comprising:
at least one lotion pipeline automatic valve disposed at the at least one lotion pipeline for opening or closing the at least one lotion pipeline; and
at least one water pipeline automatic valve disposed at the at least one water pipeline for opening or closing the at least one water pipeline.

13. The fluid supply system according to claim 7, wherein the fluid supply system further comprising:
at least one conductivity meter disposed on the lotion sink for obtaining a concentration of the lotion in the lotion sink.

14. The fluid supply system according to claim 7, wherein the flow meter is a digital vortex flow meter, a throttling flow meter, a slit flow meter, a volumetric flow meter, an electromagnetic flow meter, or an ultrasonic flow meter.

15. A fluid supply method for a fluid supply system, the fluid supply system comprising at least one lotion sink, at least one lotion pipeline and water pipeline respectively connected to the at least one lotion sink, at least two flow meters and a control device, wherein the at least two flow meters used for obtaining flow values of lotion and water respectively delivered to the lotion sink, the control device used for receiving the flow values, comprising the steps of:
(A) opening the lotion pipeline by the control device to deliver the lotion to the at least one lotion sink;
(B) judging whether an amount of the lotion in the at least one lotion sink reaches a first predetermined amount by the control device using the flow values, and executing step C if so, while returning back to step B if not;
(C) closing the lotion pipeline by the control device;
(D) opening the water pipeline by the control device to deliver the water to the at least one lotion sink;
(E) judging whether an amount of the water in the at least one lotion sink reaches a second predetermined amount by the control device using the flow values, and executing step F if so, while returning back to step E if not; and
(F) closing the water pipeline by the control device.

16. The fluid supply method according to claim 15, wherein the fluid supply system further comprising a plurality of fluid level sensors disposed on each lotion sink for transmitting a signal to the control device when a fluid level of the lotion sink is detected; before step F, further comprising a step of:
(E1) judging whether a predetermined fluid level sensor among the fluid level sensors detects the fluid level or not by the control device, and executing the step F if so.

17. The fluid supply method according to claim 15, wherein the method further comprising a step of:
(E2) stopping supplying the lotion and raising an abnormality alarm if the control device determines that the predetermined fluid level sensor fails to detect the fluid level.
